(19) United States
(12) Patent Application Publication
(10) Pub. No.: US 2010/0201116 A1
(43) Pub. Date: Aug. 12, 2010

(54) Flexible duct seal

(76) Inventors: Eric E. Kipker, Holland, MI (US); Keith Page, Zeeland, MI (US); Philip Maier, Caledonia, MI (US); Russ Verbrugge, Holland, MI (US); Michael Lutz, Grand Haven, MI (US)

Correspondence Address: Jeffrey Thurnau;Tomkins, IP Law Dept. 10-A3, 1551 Wewatta Street, Denver, CO, 80202, US

(21) Appl. No.: 12/322,724

(22) Filed: Feb. 6, 2009

(51) Int. Cl. F16L 35/00; F16J 15/10

(52) U.S. Cl. 285/24; 277/613

(57) ABSTRACT

A duct connection comprising a collar having a first tab extending radially for lockable engagement with a first duct, a flexible body having an inner surface, the flexible body extendably disposed on the outside of the collar whereby the flexible body is axially coextensive with the collar when the collar is engaged with the duct, and whereby the duct is disposed between the collar and the flexible body when the flexible body is in the axially extended position, and the flexible body sealingly engageable with the duct.

### FIELD OF THE INVENTION

The invention relates to a flexible duct seal, and more particularly, to a flexible body having an inner surface, the flexible body extendably disposed on the outside of the collar whereby the flexible body is axially coextensive with the collar when the collar is engaged with the duct, and whereby the duct is disposed between the collar and the flexible body when the flexible body is in the axially extended position, and the flexible body sealingly engageable with the duct.

### BACKGROUND OF THE INVENTION

Duct connectors are known which generally comprise metal collars. The collars are sized according to the size of duct. The collars are not flexible and do not readily accommodate misaligned duct.

Representative of the art is U.S. Pat. No. 6,390,510 B1 which discloses a swivel connection for a flexible dryer duct. The swivel connection is comprised of two sleeves, one of which can slide within the other. Each of the sleeves can be connected to a section of duct. The inner sleeve has an outwardly projecting flange that can engage an inwardly projecting flange on the outer sleeve, preventing the sleeves from being pulled apart, but allowing relative rotational movement between the sleeves.

What is needed is a flexible body having an inner surface, the flexible body extendably disposed on the outside of the collar whereby the flexible body is axially coextensive with the collar when the collar is engaged with the duct, and whereby the duct is disposed between the collar and the flexible body when the flexible body is in the axially extended position, and the flexible body sealingly engageable with the duct. The present invention meets these needs.

### SUMMARY OF THE INVENTION

The primary aspect of the invention is to provide a a flexible body having an inner surface, the flexible body extendably disposed on the outside of the collar whereby the flexible body is axially coextensive with the collar when the collar is engaged with the duct, and whereby the duct is disposed between the collar and the flexible body when the flexible body is in the axially extended position, and the flexible body sealingly engageable with the duct.

Other aspects of the invention will be pointed out or made obvious by the following description of the invention and the accompanying drawings.

The invention comprises a duct connection comprising a collar having a first tab extending radially for lockable engagement with a first duct, a flexible body having an inner surface, the flexible body extendably disposed on the outside of the collar whereby the flexible body is axially coextensive with the collar when the collar is engaged with the duct, and whereby the duct is disposed between the collar and the flexible body when the flexible body is in the axially extended position, and the flexible body sealingly engageable with the duct.

### BRIEF DESCRIPTION OF THE DRAWINGS

The accompanying drawings, which are incorporated in and form a part of the specification, illustrate preferred embodiments of the present invention, and together with a description, serve to explain the principles of the invention.

FIG. 1 is a side view of a collar connection.

FIG. 2 is a side view of a collar connection.

FIG. 3 is a side exploded view of a boot connection.

FIG. 4 is a side view of a boot connection.

FIG. 5 is a side view of a boot connection.

FIG. 6 is a perspective view of the flexible duct seal.

FIG. 9 is a side view of the flexible duct seal.

FIG. 7 is a front view of the flexible duct seal.

FIG. 8 is a section through FIG. 7.

FIG. 10 is a side view of the flexible duct seal installed on a duct.

FIG. 11 is a perspective view of the flexible duct seal installed on a duct.

FIG. 12 is a side view of an alternate embodiment.

### DETAILED DESCRIPTION OF THE PREFERRED EMBODIMENT

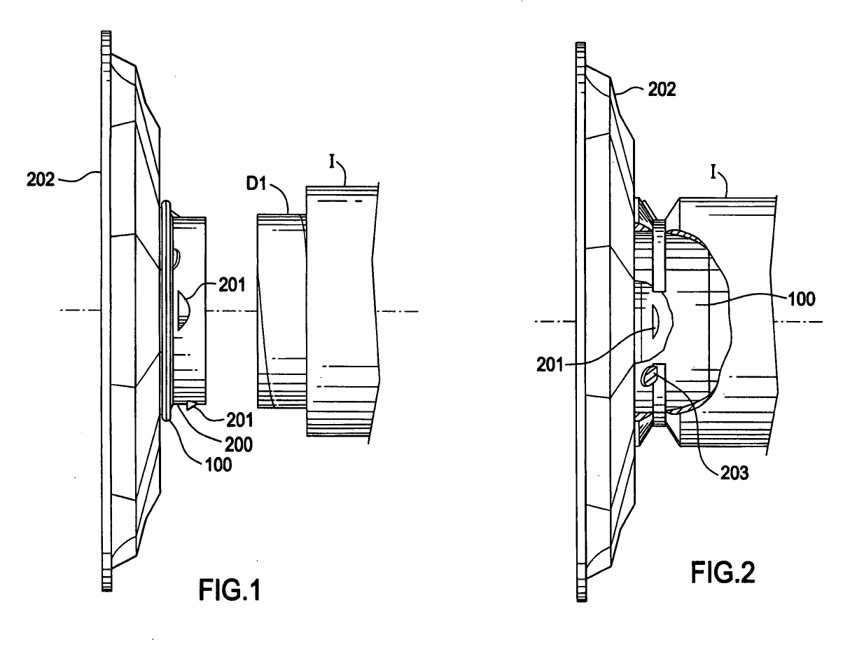

FIG. 1 is a side view of a collar connection. The duct connections described in this specification are used to connect pieces of HVAC duct. The connections can be between duct runs as well as diffusers and dampers and any other HVAC component.

In this embodiment, collar 200 is attached to diffuser 202. Collar 200 comprises lanced tabs 201. Lanced tabs 201 are punched out from the collar and extend radially outward from collar 200. Lanced tabs 201 are disposed about the outer surface of collar 200. Lanced tabs 201 frictionally engage or penetrate an inner duct surface of a duct D1 as duct D1 is pressed over collar 200.

Collar 200 typically comprises sheet metal known in the art.

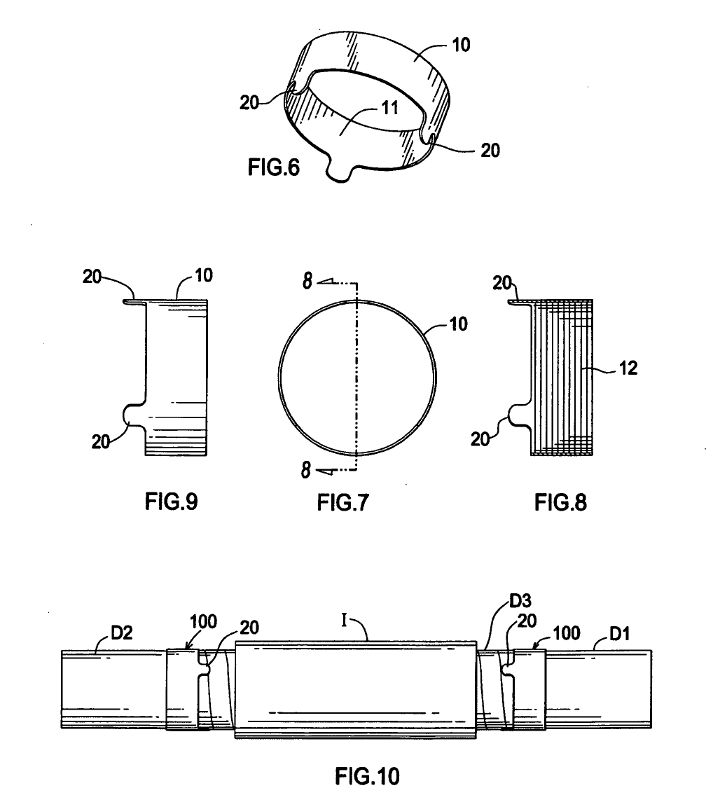

A flexible duct seal 100 is rolled up on collar 200. This would be an example of a transport mode for the invention. The flexible duct seal is more completely described in FIGS. 6, 7, 8 and 9.

A piece of duct D1 is shown in position to engage collar 200. Duct piece D1 may be un-insulated or may be covered with insulation (I) known in the art.

FIG. 2 is a side view of a collar connection. Duct D1 is shown fully engaged with collar 200. Lanced tabs 201 may frictionally engage, or, project through duct D1, thereby locking duct D1 into fixed connection to collar 200. Flexible duct seal 100 is then unrolled from collar 200 over the outer surface of duct D1, thereby creating an air tight seal at the joint between diffuser 202 and duct D1. Insulation (I) is then extended or pushed over the outside of flexible duct seal 100. A flexible strap 203 is used to secure the insulation about the joint and flexible duct seal 100. Flexible strap 203 is in the nature of what is commonly referred to as a rubber band. Duct D1 may be flexible or rigid duct known in the art.

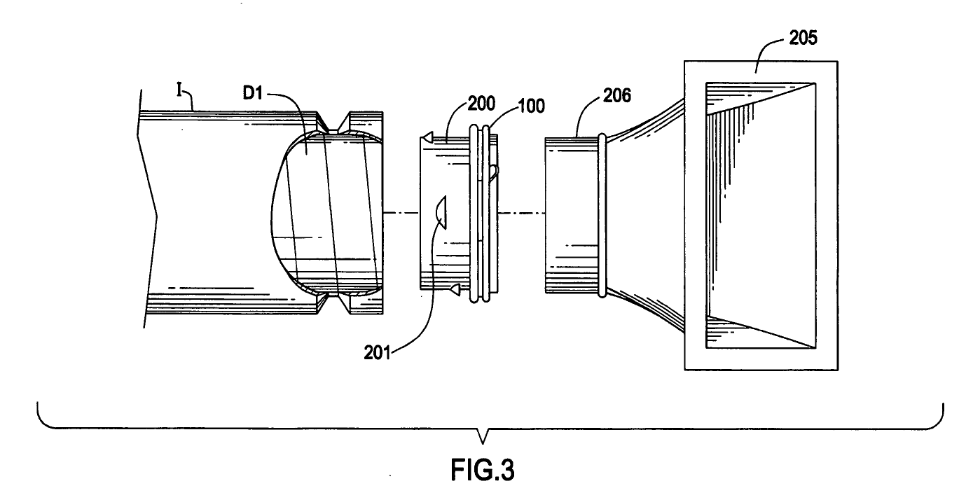

FIG. 3 is a side exploded view of a boot connection. Collar 200 comprises radially extending lanced tabs 201. Both ends of flexible duct seal 100 are rolled up and placed on the outside of collar 200. Collar 200 connected duct D1 to diffuser 205. Sleeve 206 engages inside collar 200. Collar 200 engages inside duct D1. Lanced tabs 201 engage duct D1. Diffuser 205 is known in the art.

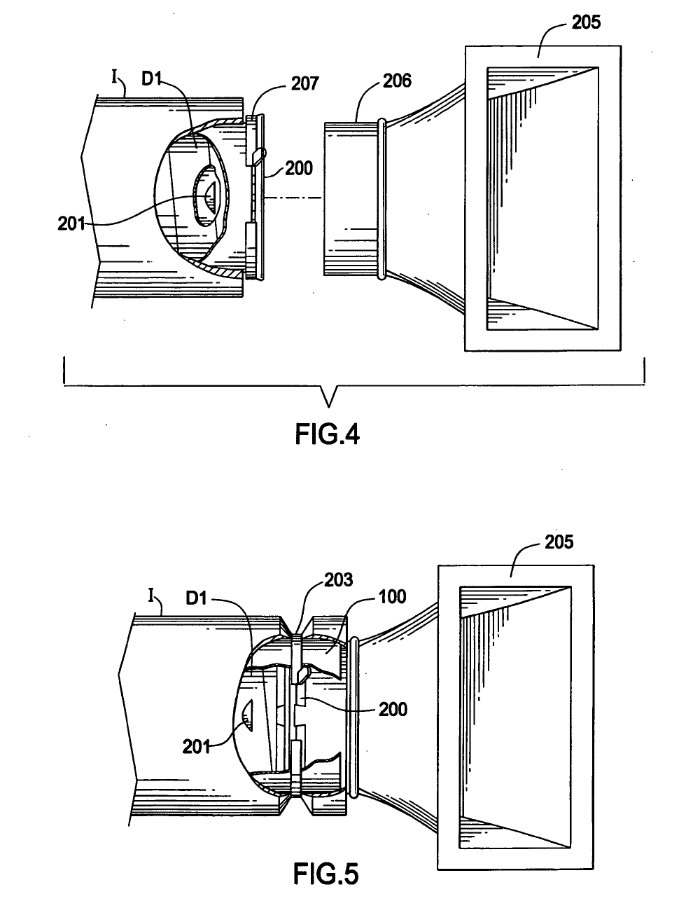

FIG. 4 is a side view of a boot connection. Collar 200 is shown inserted into duct D1. One end of the flexible duct seal 100 is unrolled over duct D1. A fastener 207 can be used to secure the flexible duct seal 100 to the outside of collar 200. FIG. 4 shows the duct D1 prior to connection to diffuser 205.

FIG. 5 is a side view of a boot connection. Collar 200 connects duct D1 to diffuser 205. The other end of flexible duct seal 100 is unrolled, thereby extending over the outside of duct D1 and over the outside of sleeve 206. Flexible strap 203 is used to secure the insulation about the flexible duct seal 100. The insulation may comprise fiberglass, mineral wool, or any other suitable insulation known in the art.

FIG. 6 is a perspective view of the flexible duct seal. The flexible duct seal 100 comprises a body 10. Body 10 is substantially cylindrical. Body 10 comprises rubber or rubber-like material. Body 10 comprises an inner surface 11. Tabs 20 extend from body 10 in a substantially coplanar manner with reference to inner surface 11. Tabs 20 can be used to pull the seal 100 over a duct joint.

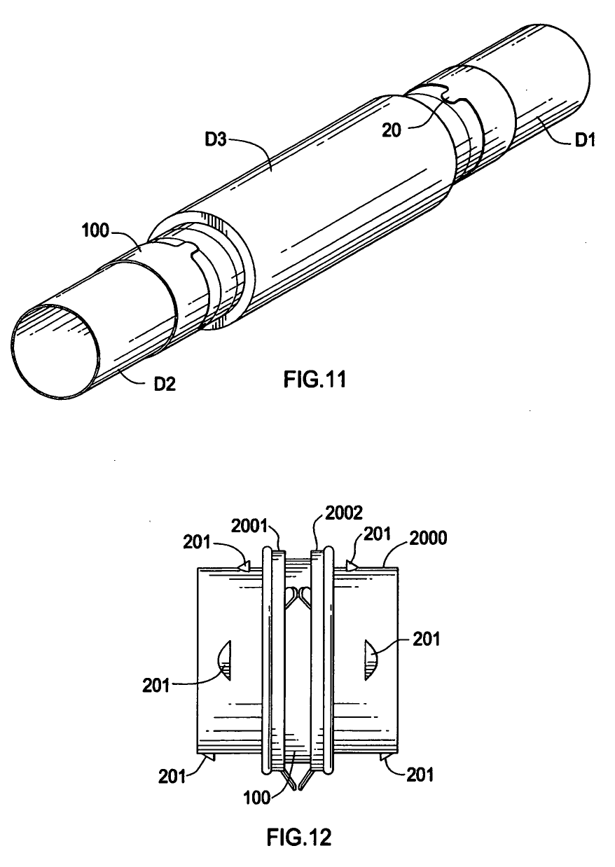

FIG. 9 is a side view of the flexible duct seal. Tabs 20 are used by a user to grip the seal 100. A user pulls on tabs 20 in unroll seal 100 across a duct joint, see FIG. 8 and FIG. 9.

FIG. 7 is a front view of the flexible duct seal. Body 10 is substantially cylindrical to facilitate installation on a round duct. The duct is typically the sort used for HVAC systems. HVAC systems generally move and distribute air or other gases.

FIG. 8 is a section through FIG. 7. Inner surface 11 comprises ridges 12 which extend about a circumference of surface 11. Ridges 12 create a gas tight seal between the seal 100 and the outer surface of a duct, see FIG. 5.

FIG. 10 is a side view of the flexible duct seal installed on a duct. Duct pieces D1, D2, and D3 are jointed by seals 100. Seals 100 are shown spanning joints between each piece of duct. Insulation I is shown on duct D3. Seal 100 may be used to join various styles of duct, including sheet metal and PVC. Insulation is omitted from duct D1 and D2 for clarity.

FIG. 11 is a perspective view of the flexible duct seal installed on a duct. The duct is round in this FIG. 11. To begin, seal 100 is rolled back on itself creating a roll. Seal 100 is shown unrolled across the joint between ducts D1, D2 and D3. Tabs 20 are used to pull the seal in order to unroll it or place it across the joint. The flexible nature of seal 100 allows it to accommodate and correct significant amounts of duct misalignment while still achieving a gas tight fit between the duct pieces being joined. The seal can also accommodate some amount of mismatch in the diameter of the duct pieces being joined.

FIG. 12 is a side view of an alternate embodiment. Collar 2000 comprises lanced tabs 201. Collar 200 typically comprises sheet metal known in the art. The collar 2000 is used to join two pieces of duct, such as duct D1 in FIG. 3. The installation is the same as described for FIG. 3, with exception that each end of collar 2000 is connected into a duct piece. Each end of seal 100 is shown rolled up and substantially centered on the collar. Once the collar is inserted into both duct pieces, see FIG. 11, each end of seal 100 is unrolled over each respective duct piece to complete the sealed connection as described elsewhere in this specification.

Straps 2001 and 2002 are used to retain seal 100 in place on collar 2000. A single strap 2001 may be used as well with equal effectiveness.

Although forms of the invention have been described herein, it will be obvious to those skilled in the art that variations may be made in the construction and relation of parts without departing from the spirit and scope of the invention described herein.

1. A flexible duct seal comprising:
a flexible body having a cylindrical form, the cylindrical form having an inner surface;
a tab extending axially from the flexible body, the tab coplanar with the inner surface;
a plurality of ridges disposed on the inner surface; and
the ridges extending about a circumference of the flexible body.

2. The flexible duct seal as in claim 1, wherein the flexible body comprises rubber.

3. The flexible duct seal as in claim 1 further comprising a plurality of tabs.

4. A duct connection comprising;
a collar having a first tab extending radially for lockable engagement with a first duct;
a flexible body having an inner surface;
a plurality of ridges disposed on the inner surface;
the ridges extending about a circumference of the flexible body;
a diffuser engaged with an end of the first duct; and
the flexible body extendably disposed on the outside of the collar whereby the flexible body is axially coextensive with the collar when engaged with the first duct.

5. The duct connection as in claim 4, wherein the collar further comprises a second tab extending from the collar for lockable engagement with a second duct.

6. The duct connection as in claim 4, wherein the flexible body comprises a tab member.

7. A duct connection comprising;
a collar having a first tab extending radially for lockable engagement with a duct;
a flexible body having an inner surface;
the flexible body extendably disposed on the outside of the collar whereby the flexible body is axially coextensive with the collar when the collar is engaged with the duct, and whereby the duct is disposed between the collar and the flexible body when the flexible body is in an axially extended position;
a flexible strap to secure insulation about the flexible body;
a diffuser engaged with an end of the duct; and
the flexible body sealingly engageable with the duct.

8. The duct connection as in claim 7 further comprising:
a plurality of ridges disposed on the inner surface of the flexible body; and
the ridges extending about a circumference of the flexible body.

9. The duct connection as in claim 7, wherein the collar further comprises a second tab extending from the collar for lockable engagement with a second duct.

10. The duct connection as in claim 7, wherein the flexible body comprises a tab member.

11. (canceled)
